(19) United States
(12) Patent Application Publication
(10) Pub. No.: US 2026/0094203 A1
(43) Pub. Date: Apr. 2, 2026

(54) PHYSICAL ADVERTISEMENT SPACE INVENTORY SYSTEM AND METHOD

(71) Applicant: Richard Gelman, New York, NY (US)

(72) Inventor: Richard Gelman, New York, NY (US)

(21) Appl. No.: 18/900,235

(22) Filed: Sep. 27, 2024

(51) Int. Cl. G06Q 30/0645; G06Q 30/0272

(52) U.S. Cl. CPC G06Q 30/0645; G06Q 30/0272

(57) ABSTRACT

In an embodiment, a physical advertisement space inventory system is disclosed. The system includes an inventory database that stores inventory data. The inventory data represents a plurality of physical advertisement spaces available for lease and includes at least data representing a price, location, and availability of the advertisement spaces. A web application is configured to present stored inventory data of a given advertisement space from the inventory database in response to a request from a user. The web application is further configured to receive a selection of the given advertisement space for a selected lease period and generate and present a lease contract for the given advertisement space. The contract includes the price, location, and selected lease period for the given advertisement space. The web application is further configured to enable an acceptance of and a payment for the contract.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to the field of advertising, and in particular, a physical advertisement space inventory system.

The first billboards were invented in the 1830s and became a popular form of advertising in the 1860s. Businesses were able to purchase billboard advertisement space to convey messages, launch new products and services, build brand awareness, and reach a vast audience. Billboards are typically located in high-traffic areas, such as busy intersections, highways, major city streets, and near popular attractions. By choosing prime locations, advertisers can maximize their exposure to a diverse audience, including sports fans in stadiums, motorists on the highway, pedestrians in large cities, shoppers in retail malls, and commuters waiting for the bus. These placements ensure that the advertiser's message reaches a wide range of demographics, making billboards and physical ad space a powerful medium for brand promotion.

Today, billboards still comprise a large percentage of the advertising market. For fiscal year 2024, the global billboard and outdoor advertising market is estimated to generate approximately $45 billion in revenue, with billboards generating approximately $8 billion in the United States alone. Many advertisers are now looking to digital methods in addition to traditional billboards. Digital billboards involve less work and fewer overhead costs while delivering a more vivid and engaging form of advertising. An advertiser can easily experiment with colors, fonts, styles and sound effects and upload a design file in seconds instead of shipping an advertisement to a billboard company weeks in advance.

From its rather humble beginnings, billboard advertising has exploded and continues to be a powerful advertising tool. Its ability to captivate audiences, generate brand awareness, and convey messages efficiently contributes to its enduring popularity. However, the process of renting or booking a billboard and other physical ad space can be tedious, cumbersome, and frustrating. Securing a desired advertisement space involves contacting ad space owners, collecting a litany of information regarding location, price, availability, booking requirements, and other details, investing time and energy into negotiating the specifics, and potentially being met with disappointment when another advertiser beats one to a high-demand space.

More recent forms of physical advertisement spaces include signage on taxi tops, ice rink boards, stadium home run walls, digital kiosks, and graphic overlays during sporting events. However, these advertisement spaces present similar problems to traditional billboards in that their value is difficult to assess and they are tedious to book. Thus, there is a need for an improved method and system for renting physical advertisement space.

The present invention addresses the limitations of traditional advertisement space leasing approaches and offers a modern advertising solution to streamline billboard renting, enhance marketing effectiveness and advertisement campaign performance. Billboards may comprise all physical signage, such as stadium and venue displays, ice rink walls, shopping mall walls and in-mall interactive store map kiosk displays, signage throughout airport terminals, taxi top displays, creative wallscapes, waiting room displays, bus and car wraps, bike rental kiosks, light pole banners, in-elevator displays, street benches, bus stop shelters, hotel in-room and lobby kiosks, EV charging station displays, gym walls and equipment displays, and other spaces. By making it easier, faster, more accessible and less cumbersome to find and lease advertisement space, the present invention will significantly increase the revenue potential of the billboard and outdoor advertising market.

### SUMMARY

The present invention comprises a physical advertisement space inventory system. The system comprises an inventory database that stores inventory data. The inventory data represents a plurality of physical advertisement spaces available or unavailable for lease or for sale, and comprises data representing a price, location, and availability of the advertisement spaces. A web application is configured to recall and present stored inventory data of a given advertisement space from the inventory database in response to a request from a user. The web application is further configured to receive a selection of the given advertisement space for a selected lease period, such as a duration of a sporting event, and generate and present a lease contract for the given advertisement space. The contract comprises the price, location, and selected lease period for the given advertisement space. The web application is further configured to enable an acceptance of and a payment for the contract.

In some embodiments, the inventory data of the given advertisement space further comprises whether the given advertisement space is configured to display static and/or digital content. The inventory data may further comprise a visual rendering of the given advertisement space. The inventory data may further comprise an advertisement space score that is calculated based on variables comprising location, size, illumination, traffic data comprising number of daily impressions and impression duration of the given advertisement space, and quick-response (QR) code interaction rates such as an average number of QR code interactions per unit of time for the given advertisement space.

In some embodiments, the web application is further configured to allow searches of the inventory database by the user based on any of the inventory data. The web application may be further configured to receive files comprising design specifications, content, and materials for an advertisement campaign for display on a selected advertisement space. The web application may be further configured to receive the files comprising design content and materials and display the files in the selected advertisement space in real-time.

In some embodiments, the lease period for the given advertisement space comprises a short-term period of seconds, minutes, hours, days, or weeks. In some embodiments, the lease period for the given advertisement space comprises all or some of a duration of an event. In some embodiments, the lease period for the given advertisement space comprises a monthly or annual subscription.

In another embodiment, a method performed by at least one processor comprising hardware is disclosed. The method comprises calculating, by a web application, an advertisement space score for a given physical advertisement space from an inventory database. The advertisement space score is calculated based on variables comprising location, size, illumination, and traffic data comprising number of daily impressions and impression duration of the given advertisement space, and QR code interaction rates such as an average number of QR code interactions per unit of time for the given advertisement space. Stored inventory data of the given advertisement space from the inventory database is presented by the web application in response to a request from a use. The inventory data represents a plurality of physical advertisement spaces available for lease and comprises at least data representing a price, location, availability and the advertisement space score of the advertisement spaces. A selection of the given advertisement space for a selected lease period is received by the web application.

A lease contract for the given advertisement space is generated and presented by the web application. The contract comprises the price, location, and selected lease period for the given advertisement space. An acceptance of and a payment for the contract is enabled.

In some embodiments, calculating an advertisement space score for a given advertisement space comprises calculating an advertisement space score for a given advertisement space based on variables that are weighted, and wherein location is assigned a higher weight than other weighted variables.

In some embodiments, the method further comprises generating a QR code for the given advertisement space, displaying the generated QR code on the given advertisement space, and counting a number of scans of the QR code in a given amount of time. The traffic data may further comprise the number of scans of the QR code in a given amount of time.

Since the very first billboards, it has been difficult to prove a passer-by has viewed a particular physical sign or determine if an advertising impression factually took place. It is possible for somebody to walk by a sign without viewing it. This embodiment, however, solves that predicament—a QR code interaction proves that an advertisement impression took place. In some embodiments, an advertising score can be calculated and assigned as a function of QR code interactions and QR code interaction rates. Pixel scans provide evidence that a sign has been viewed.

In some embodiments, presenting stored inventory data of the given advertisement space further comprises presenting whether the given advertisement space is configured to display static and/or digital content. Presenting stored inventory data of the given advertisement space may further comprise presenting a visual rendering of the given advertisement space.

In some embodiments, the web application is further configured to allow searches of the inventory database by the user based on any of the inventory data.

In some embodiments, the method further comprises receiving files comprising design materials for an advertisement campaign for display on a selected advertisement space. The method may further comprise receiving the files comprising design content and materials and displaying the files in the selected advertisement space in real-time. In some embodiments, the lease period for the given advertisement space comprises a seasonal, daily, weekly, monthly or annual subscription.

In another embodiment, non-transitory computer-readable media comprising program code that when executed by a programmable processor causes execution of a method is disclosed. The computer readable media comprises computer program code for calculating an advertisement space score for a given physical advertisement space from an inventory database. The advertisement space score is calculated based on variables comprising location, size, illumination, and traffic data comprising number of daily impressions and impression duration of the given advertisement space. According to an embodiment, the advertisement space score is calculated based on additional variables comprising a documented number of physical interactions between viewers and the sign, the number being determined based on a number of digital, touchscreen, or QR code interactions for a given advertisement space over a unit of time.

The computer readable media further comprises computer program code for recalling and presenting, in response to a request from a user, stored inventory data of the given advertisement space from the inventory database. The inventory data represents a plurality of physical advertisement spaces available for lease or sale and comprises data representing a price, location, availability and the advertisement space score of the advertisement spaces. The computer readable media further comprises computer program code for receiving a selection of the given advertisement space for a selected lease period and for generating and presenting a lease or sale contract for the given advertisement space. The contract comprises the price, location, and selected lease period as well as sign identification details for the given advertisement space. The computer readable media further comprises computer program code for enabling an acceptance of and a payment for the contract.

In another embodiment, a physical advertisement space inventory system is disclosed. The system comprises an inventory database that stores inventory data. The inventory data represents a plurality of physical advertisement spaces available for lease or sale and comprises data representing a location and availability of the advertisement spaces. A web application is configured to recall and present stored inventory data of a given advertisement space from the inventory database in response to a request from a user. The web application is further configured to receive a selection of the given advertisement space for a selected lease period. The web application is further configured to facilitate communication between the user and an owner of the given advertisement space to negotiate a price for leasing the given advertisement space for the selected lease period. The web application is further configured to generate and present a lease contract for the given advertisement space. The contract comprises the price, location, and selected lease period for the given advertisement space. The web application is further configured to enable an acceptance of and a payment for the contract.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a diagram of a physical advertisement space inventory system according to embodiments of the present invention.

FIGS. 2A-2C are a flow diagram of an example process for purchasing physical advertisement space according to embodiments of the present invention.

FIGS. 3A-3C are a flow diagram of an example process for listing physical advertisement space for sale according to embodiments of the present invention.

FIG. 4 is a flow diagram of an example process for providing content for display on a physical advertisement space according to embodiments of the present invention.

FIGS. 5A-5B are a flow diagram of an example checkout process for purchasing physical advertisement space according to embodiments of the present invention.

FIGS. 6A-6B are a flow diagram of an example money flow process when purchasing physical advertisement space according to embodiments of the present invention.

FIG. 7 is a flow diagram of an example process for inventoried physical advertisement space according to embodiments of the present invention.

FIGS. 8 through 14 are exemplary web application interfaces of a physical advertisement space inventory system according to embodiments of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

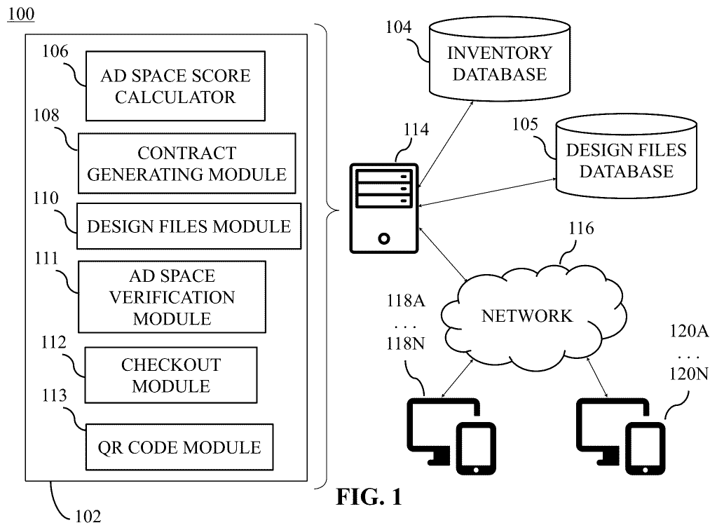

With reference to FIG. 1, a physical advertisement space inventory system 100 is disclosed in accordance with embodiments of the invention. System 100 comprises user devices 118A-118N used by advertisers/advertisement space purchasers and owner devices 120A-120N used by advertisement space owners. System 100 further comprises a server 114 configured to store web application 102 of the present invention. Network 116 is configured to connect user devices 118 and owner devices 120 with server 114 and web application 102.

User devices 118 and owner devices 120 may include a smartphone, tablet, laptop, desktop, palmtop, television, or any other computing device configured to execute the functionality described herein. In some embodiments, web application 102 may be implemented as a native application or other software form. In some embodiments, web application 102 is in the form of a web page, widget, and/or Java, JavaScript, and/or other applet or plug-in that is downloadable to the user device and runs in conjunction with a web browser. Web application 102 and the web browser can be part of a single client-server interface; for example, web application 102 can be implemented as a plugin to the web browser or another framework or operating system. Any other suitable client software architecture, including but not limited to a widget framework and applet technology, can also be employed.

Owner devices 120 may upload their inventory of advertisement spaces, set prices, and include renderings of the advertisement spaces so that user devices 118 may see how their ad will look to viewers. Inventory database 104 stores inventory data representing the physical advertisement spaces available for purchase. It should be noted that the right to display an advertisement on a given advertisement space is the object of the purchase/sale/lease, rather than the advertisement space itself (i.e., the billboard or other signage). In other words, the physical advertisement spaces are available to purchase or lease. In another embodiment, web application 102 of system 100 is configured allow owner devices 120 to sell advertisement spaces. Here, user device 118 purchases legal title to the advertisement space from owner device 120 rather than merely leasing the right to display an advertisement on the advertisement space.

The inventory data stored in inventory database 104 may include data representing a price, location, and availability of the advertisement spaces. In some embodiments, the inventory data further includes whether the advertisement spaces are configured to display static and/or digital content and a visual rendering of the advertisement spaces. The lease or purchase period of an advertisement space may be a short-term period of a certain number of seconds, minutes, hours, days, or weeks. The lease or purchase period may be all or some of the duration of an event, for example, all or half of the Super Bowl. In some embodiments, the purchase period may be a seasonal, daily, weekly, monthly or annual subscription.

According to an embodiment, system 100 is configured to allow owner devices 120 to upload their inventory of advertisement spaces without setting a price. If user device 118 is interested in leasing a given advertisement space shown without a price quote, system 100 may connect user device 118 and owner device 120 to communicate with each other to discuss and negotiate price. After agreeing on a price, user device 118 and owner device 120 are returned to web application 102 to complete the transaction for leasing or purchasing the given advertisement space. In another embodiment, web application 102 is configured to communicate with user device 118 and owner device 120 to work out a price for leasing an advertisement space for a lease or purchase period. The functionality discussed with reference to these embodiments would be particularly useful for high-end leases such as a lease for stadium naming rights, but may be applicable to any physical advertisement space listing.

Web application 102 allows user devices 118 to purchase physical advertisement space in real time based on prices set by owner devices 120. Such physical advertisement space includes billboards, stadium and venue signage, ice rinks, shopping malls, airports, taxi top ad banners, wallscapes, waiting room displays, bus wraps, bike rental kiosks, light pole banners, in-elevator displays, street benches, bus shelters, hotel in-room and lobby kiosks, EV charging station displays, gym walls and equipment displays, and other spaces. Web application 102 comprises multiple software modules including advertisement space score calculator 106, contract generating module 108, design files module 110, advertisement space verification module 111, checkout module 112, and quick-response (QR) code module 113.

System 100 is configured to receive, by design files module 110, files comprising design specifications, content, and materials for an advertisement campaign and to display the files on a selected advertisement space. As long as user device 118 pays for a given advertisement space, user device 118 may upload design materials comprising any type of content for display on the given advertisement space (e.g., a happy birthday wish, a public service message, a congratulatory note, etc.). The design files are stored in design files database 105. As such, advertisement spaces that are configured to display digital content may be purchased in real time. For example, an advertiser can pay a premium to purchase an advertisement space configured to display digital content at Yankee Stadium to advertise something relevant during a baseball game. In an embodiment, web application 102 is configured to receive the files comprising design materials and display the files in the selected advertisement space in real time.

According to an embodiment, ad space score calculator 106 of system 100 utilizes an algorithm to calculate an advertisement space score. The advertisement space score may be calculated based on variables such as location, size, illumination, and traffic data comprising number of daily impressions and impression duration of the given advertisement space. The advertisement space score may also be calculated based on a number of physical interactions between viewers and a given advertisement, the number being recorded based on a number of digital, touchscreen, or QR code interactions over a given period of time. In some embodiments, system 100 provides a dashboard comprising analytics and inventory data including the advertisement space score for owners and advertisers to reference when making purchase decisions.

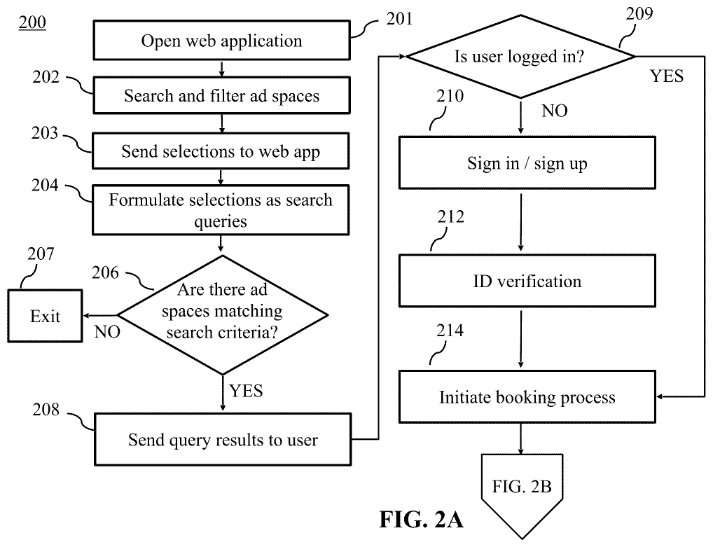

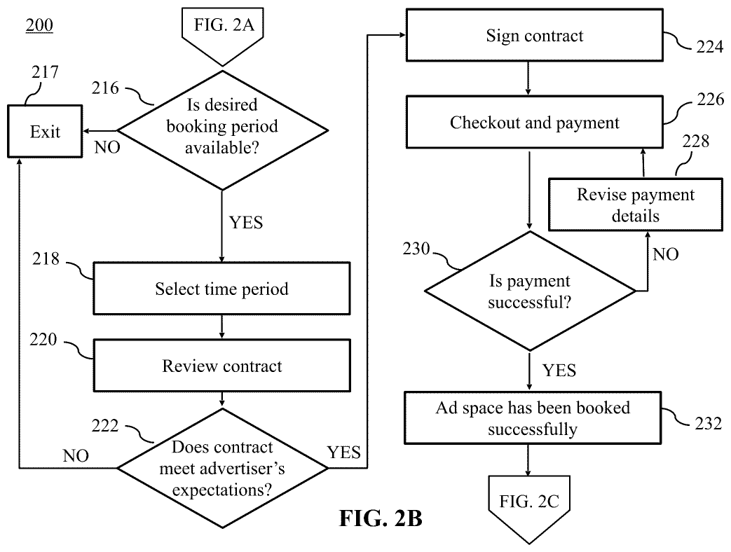

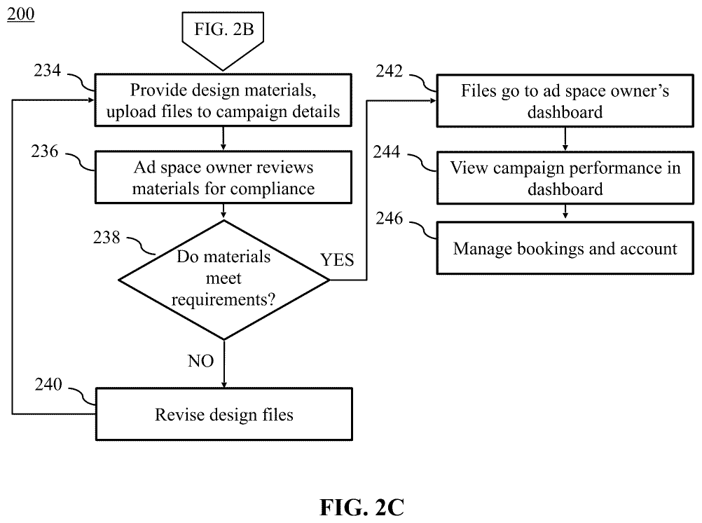

With reference to FIG. 2, a process 200 of using system 100 to purchase physical advertisement space in accordance with some embodiments will now be described. The process of FIG. 2 comprises steps 201 through 246 and is suitable for use in system 100 but is more generally applicable to other types of systems for purchasing physical advertisement space.

At step 201, user device 118 opens and accesses web application 102. At step 202, user device 118 may utilize one or more filters to search for advertisement spaces. For example, user device 118 may filter advertisement spaces based on any of the inventory data. In some embodiments, user device 118 may filter advertisements spaces by date (e.g., campaign start and end date), purchase or booking period (e.g., months, years), availability, ad space type and size (e.g., ice rink, baseball field, mobile billboard, car top display, billboard, bike rental kiosk, poster, jr. poster, premier square, wallscapes, etc.), advertising type (e.g., static, digital), illumination (e.g., illuminated, not illuminated), price range, point of interest (e.g., city, highway, airport, stadium, indoor mall, outdoor mall, casino, hospital, train station, bus station, movie theater, Broadway theater, food court, museum, gym, tourist spot, landmark, university, residential area, commercial area, beach, amusement park, Times Square, fashion outlet, hockey rink, race track, waiting room, hotel, etc.). User device 118 may also select to sort the search results by popularity, advertisement space score, or price.

At step 203, the selections made by user device 118 in step 202 are sent to web application 102. At step 204, web application 102 formulates the selections as search queries to query inventory database 104. At step 206, inventory database 104 runs the search queries to check whether any advertisement spaces match the search criteria.

At step 208, the search query results including the corresponding advertisement space details stored in inventory database 104 are sent to user device 118. The advertisement space details may comprise data representing a price, location, sign identification details, and availability of the advertisement space. Other details may include the advertisement space score, purchase period option, estimated monthly traffic, ad space size, whether the advertisement space is configured to display static and/or digital content, a visual rendering of the advertisement space, whether the advertisement space is illuminated, and point of interest. If no advertisement spaces match the selected search criteria, web application 102 exits the search (step 207) and user device 118 may revise their search criteria.

At step 209, web application 102 checks if user device 118 is logged in—if so, the booking process for the selected advertisement space is initiated (step 214). If not, web application 102 prompts user device 118 to sign in or sign up for an account (step 210) and proceed to ID verification (step 212). In another embodiment, steps 209-212 are performed after step 201, before step 202.

Once the booking process is initiated, at step 216, web application 102 checks if the desired booking period is available. If not, web application 102 exits the booking process (step 217) and user device 118 may revise their desired booking period or select a different advertisement space. If the desired booking period is available for the selected advertisement space, process 200 proceeds to step 218 and user device 118 may select a purchase period. Contract generating module 108 of system 100 utilizes a stored template contract to generate and present a contract of sale or lease contract for the advertisement space. The stored template contract comprises blank placeholders for data such as price, location, and purchase period for the advertisement space. Contract generating module 108 automatically fills in the data for the selected advertisement space to complete the contract before presenting it to user device 118.

In another embodiment, the booking request is sent to owner device 120. Once the booking request is approved, user device 118 receives a confirmation and the contract for their review.

At step 220, user device 118 reviews the contract. If the contract does not meet expectations, web application 102 exits the booking process (step 217) and user device 118 may select a different advertisement space. If the contract meets expectations, at step 224, user device 118 may sign the contract. In some embodiments, user device 118 may sign the contract using electronic or digital methods including DocuSign™, Adobe™ Sign, HelloSign™, and other electronic signature services.

At step 226, process 200 proceeds to checkout and payment using checkout module 112. At step 230, checkout module 112 checks if payment is successful—if not, user device 118 may revise their payment details at step 228 and retry the checkout and payment at step 226. If the payment is successful, process 200 proceeds to step 232 and the advertisement space has been booked successfully.

At step 234, user device 118 provides files comprising design materials for their advertising campaign to design files module 110. The files are stored in design files database 105 and uploaded to the campaign details. At step 236, owner device 120 reviews the files for compliance. At step 238, design files module 110 checks whether the files meet predefined requirements - if not, at step 240, user device 118 may revise the design files and process 200 proceeds to step 234. If the files meet predefined requirements, at step 242, the files go to the dashboard of owner device 120, from which owner device 120 can view details of the campaign including campaign performance (step 244), as well as manage their bookings and account (step 246).

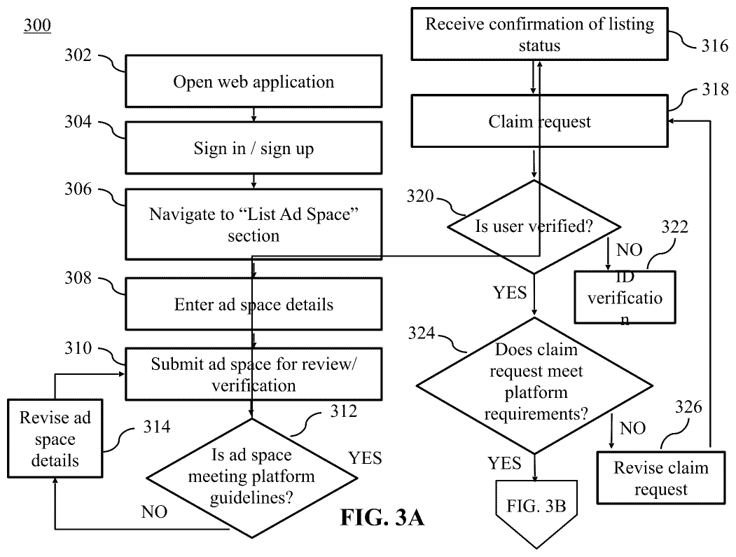

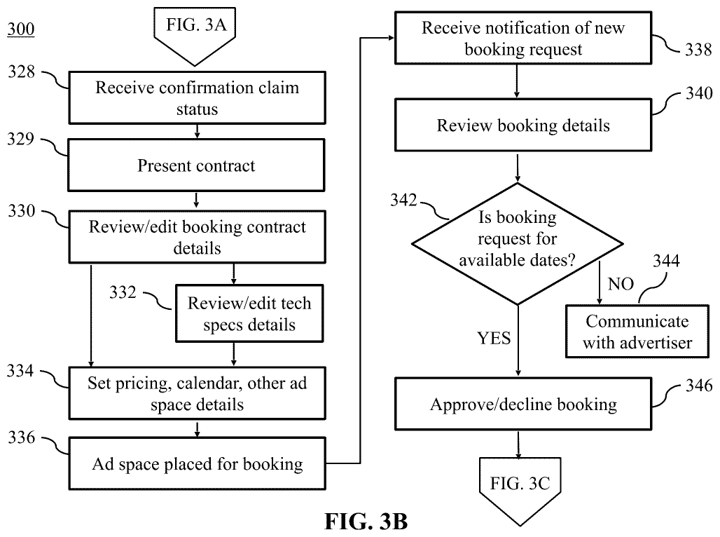

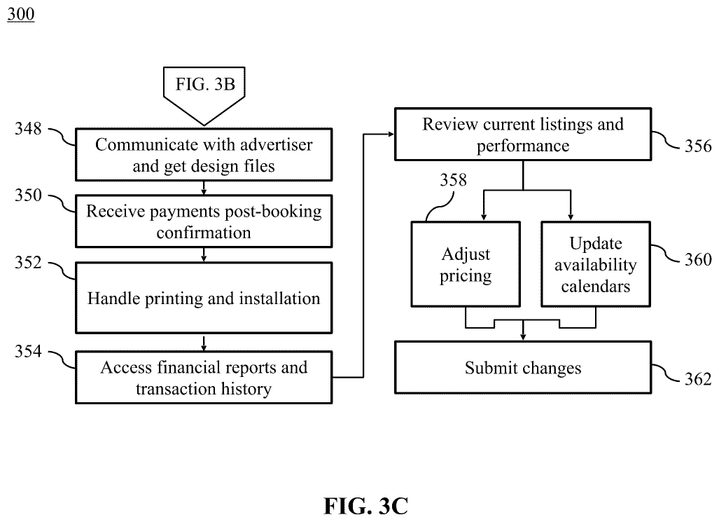

With reference to FIG. 3, a process 300 of using system 100 to list physical advertisement space for sale in accordance with some embodiments will now be described. The process of FIG. 3 comprises steps 302 through 362 and is suitable for use in system 100 but is more generally applicable to other types of systems for listing physical advertisement space for sale.

At step 302, owner device 120 opens and accesses web application 102. At step 304, owner device 120 may sign into their pre-existing account or sign up to create a new account. At step 306, owner device 120 navigates to a section of web application 102 for listing an advertisement space. At step 308, owner device 120 enters details about the advertisement space, including data representing a price, location, and availability of the advertisement space. Other details may include the advertisement space score, purchase period option, estimated monthly traffic, ad space size, whether the advertisement space is configured to display static and/or digital content, a visual rendering of the advertisement space, whether the advertisement space is illuminated, and point of interest. These details about the advertisement space are stored in inventory database 104.

At step 310, owner device 120 submits the advertisement space for review and verification. At step 312, web application 102 checks whether the advertisement space meets platform guidelines. Advertisement space verification module 111 automatically compares data received from owner device 120 regarding the advertisement space against stored parameters comprising platform guidelines.

If advertisement space verification module 111 determines that the advertisement space does not meet platform guidelines, any discrepancies between the data received and the stored parameters are communicated to owner device 120. At step 314, owner device 120 revises the advertisement space details. At step 310, owner device 120 re-submits the advertisement space for review and verification. If the advertisement space meets platform guidelines, process 300 proceeds to step 316, at which owner device 120 receives a confirmation of the listing status of their advertisement space (e.g., approved, pending, needs revision).

At step 318, owner device 120 receives a claim request submitted by user device 118. At step 320, web application 102 checks whether user device 118 is verified—if not, process 300 proceeds to step 322 for ID verification of user device 118. If user device 118 is verified, at step 324, web application 102 checks whether the claim request meets platform requirements. If not, user device 118 revises the claim request at step 326 and submits the revised claim request at step 318. If the claim request meets platform requirements, at step 328, owner device 120 receives a confirmation of the claim status.

At step 329, contract generating module 108 of system 100 utilizes a stored template contract to present a contract of sale for the advertisement space. The stored template contract comprises blank placeholders for data such as price, location, and purchase period for the advertisement space. At step 330, owner device 120 reviews and edits details of the contract of sale. At step 332, owner device 120 reviews and edits the technical specification details for the advertisement space. At step 334, owner device 120 sets pricing, calendar, and other advertisement space details such as purchase period availability. Contract generating module 108 automatically fills in the data comprising the set price, location, and purchase period for the advertisement space to complete the contract.

At step 336, the advertisement space is placed for booking, and at step 338, owner device 120 receives a notification of the new booking request. At step 340, owner device 120 reviews the booking details. At step 342, if the booking request is available for the selected dates, owner device 120 may approve or decline the booking at step 346. If the booking request is not available for the selected dates, at step 344, owner device 120 communicates the unavailability with user device 118 so that user device 118 may select a different purchase period.

At step 348, owner device 120 communicates with user device 118 to get files comprising design materials for the advertising campaign. The files are uploaded to design files module 110. At step 350, owner device 120 receives payment for the booking and a post-booking confirmation. At step 352, web application 102 handles printing and installation of the advertisement. In some embodiments, where the advertisement space is digital, web application 102 handles uploading and installation of the advertisement for real time display.

According to an embodiment, at step 354, owner device 120 may access financial reports and transaction history for previous payments for advertisement space sales. At step 356, owner device 120 may review their current listings and performance. At steps 358 and 360, owner device 120 may adjust the pricing and update the availability calendars for their listings to block out unavailable dates, respectively. Owner device 120 may submit the changes comprising such adjustments and updates at step 362.

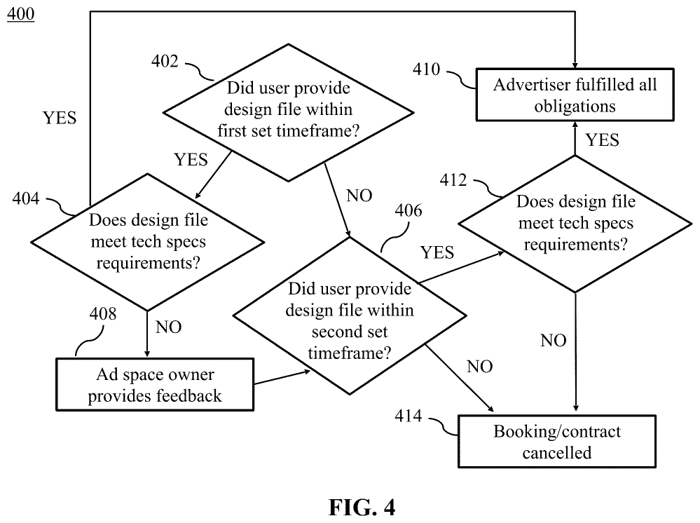

With reference to FIG. 4, a process 400 of using system 100 to provide content for display on a physical advertisement space in accordance with some embodiments will now be described. The process of FIG. 4 comprises steps 402 through 414 and is suitable for use in system 100 but is more generally applicable to other types of systems for providing content for display on a physical advertisement space.

At step 402, design files module 110 of system 100 checks whether user device 118 provided their design file for display on a booked physical advertisement space within a first set timeframe. In some embodiments, the first set timeframe is 21 days before the start date of the advertisement campaign. If the design file was not provided within the first set timeframe, at step 406, design files module 110 checks whether user device 118 provided the design file within a second set timeframe. In some embodiments, the second set timeframe is 14 days before the start date of the advertisement campaign. In some embodiments, additional flexibility in timeframes for providing the design file is possible if user device 118 and owner device 120 have, for example, the ability to communicate with each other to discuss revisions and new iterations of the design file.

If the design file was provided within the first set timeframe, process 400 proceeds to step 404 to check whether the design file meets technical specification requirements. If the design file meets technical specification requirements, at step 410, user device 118 has fulfilled all obligations for booking the advertisement space. According to an embodiment, after step 410, the status of the advertisement campaign is changed to “waiting for start.”

If the design file does not meet technical specification requirements, at step 408, owner device 120 provides feedback detailing required adjustments to user device 118. According to an embodiment, owner device 120 has 2 days from the confirmation that the design file meets technical specification requirements to provide feedback to user device 118. According to an embodiment, user device 118 may then revise and resubmit the design file. At step 406, design files module 110 checks whether user device 118 provided the revised design file within the second set timeframe. At step 414, if user device 118 did not provide the revised design file within the second timeframe, the booking and contract of sale are cancelled. According to an embodiment, any pre-payment or deposit submitted by user device 118 is lost upon such cancellation. In some embodiments, the booking and contract are not cancelled where additional flexibility in timeframes for providing the design file is possible if user device 118 and owner device 120 have, for example, the ability to communicate with each other to extend the set timeframes by an agreed upon number of days.

If user device 118 provided the design file or the revised design file within the second set timeframe, at step 412, design files module 110 checks wither the design file meets the technical specification requirements. If not, the booking and contract are cancelled at step 414. If the design file meets the technical specification requirements, user device 118 has fulfilled all obligations for booking the advertisement space at step 410.

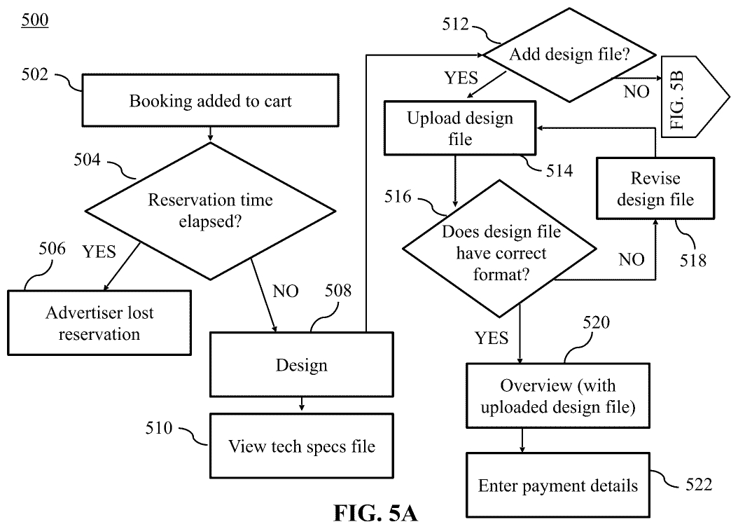

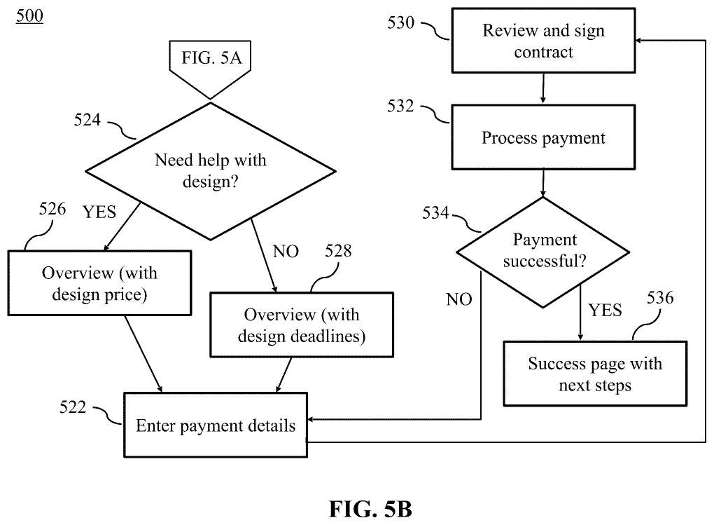

With reference to FIG. 5, a checkout process 500 of using system 100 to purchase a physical advertisement space in accordance with some embodiments will now be described. The process of FIG. 5 comprises steps 502 through 536 and is suitable for use in system 100 but is more generally applicable to other types of systems for providing content for display on a physical advertisement space.

At step 502, user device 118 adds a booking reservation for a physical advertisement space to their online cart. At step 504, checkout module 112 checks whether a predetermined reservation time has elapsed. In an embodiment, the predetermined reservation time may comprise five minutes. At step 506, if the predetermined reservation time has elapsed, user device 118 loses their reservation. At step 508, if the predetermined reservation time has not elapsed, process 500 proceeds to design for the advertisement. At step 510, user device 118 may view a technical specifications file.

Whether or not user device 118 views the technical specifications file, at step 512, design files module 110 prompts user device 118 to add a design file. At step 514, user device 118 uploads a design file comprising design materials for the advertising campaign. At step 516, design files module 110 checks whether the design file has a correct format—if not, at step 518, user device 118 may revise the design file and upload the revised design file at step 514. If the design file is in the correct format, at step 520, web application 102 presents an overview of the booking details including the uploaded design file, the name and address of the selected advertisement space, the booking dates, and the purchase price. The purchase price may comprise the full price of the advertisement space, a pre-payment or deposit amount, and any applicable taxes and service fees. According to an embodiment, the overview of the booking details is shown once payment for the booking is complete. At step 522, user device 118 enters payment details to complete the booking using checkout module 112.

If user device 118 does not add a design file once prompted at step 512, at step 524, design files module 110 asks user device 118 whether they would like assistance with the design. If user device 118 elects to have help with the design, web application 102 presents an overview of the booking details including the name and address of the selected advertisement space, the booking dates, and the purchase price (step 526). The purchase price may comprise the full price of the advertisement space, a pre-payment or deposit amount, the cost of design services, and any applicable taxes and service fees. If user device 118 elects not to have help with the design, web application 102 presents an overview of the booking details including the name and address of the selected advertisement space, the booking dates, relevant deadlines by which user device 118 must provide the design, and the purchase price (step 528). The purchase price may comprise the full price of the advertisement space, a pre-payment or deposit amount, and any applicable taxes and service fees. In some embodiments, the design timeframes discussed in accordance with process 400 may be applicable as design deadlines. According to an embodiment, the overview of the booking details is shown once payment for the booking is complete.

At step 522, user device 118 enters payment details including a billing address to complete the booking using checkout module 112. In accordance with process 200, contract generating module 108 of system 100 generates and presents a contract of sale for the advertisement space. According to an embodiment, the contract is presented with the overview of the booking details. At step 530, user device 118 reviews and signs the contract. At step 532, checkout module 112 processes the payment for the booking. At step 534, checkout module 112 checks whether the payment was successful—if not, user device 118 is prompted to enter their payment details at step 522. If payment is successful, at step 536, user device 118 is presented with a success page including next steps for their advertisement campaign.

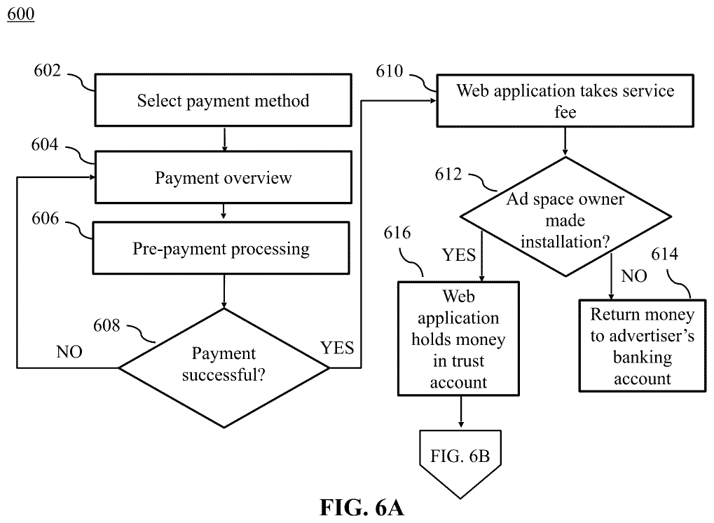

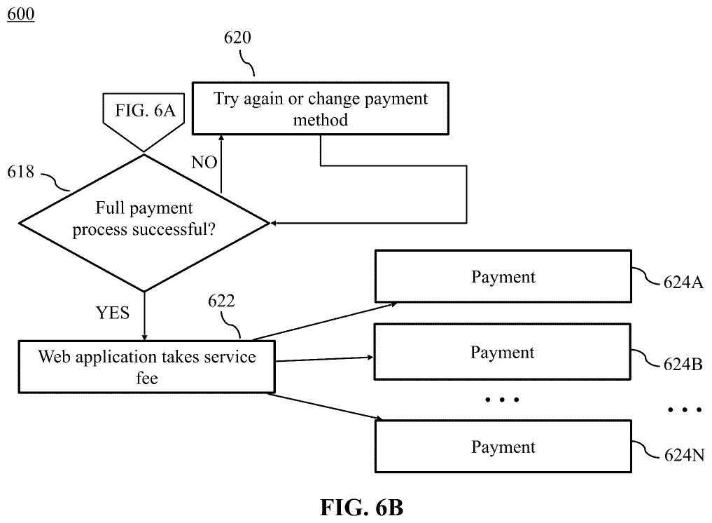

With reference to FIG. 6, a money flow process 600 when using system 100 to purchase a physical advertisement space in accordance with some embodiments will now be described. The process of FIG. 6 comprises steps 602 through 624 and is suitable for use in system 100 but is more generally applicable to other types of systems for a money flow process when purchasing a physical advertisement space.

At step 602, user device 118 selects a payment method for completing a pre-payment or deposit for their booking. At steps 604 and 606, checkout module 112 presents user device 118 with a payment overview and processes the pre-payment. At step 608, checkout module 112 checks whether pre-payment was successful—if not, user device 118 is returned to the payment overview at step 604. According to an embodiment, if pre-payment is successful, at step 610, web application 102 takes a service fee which is deposited into a trust account. According to an embodiment, web application 102 holds any taxes charged and collected for the pre-payment in the trust account. At step 612, web application 102 checks whether the owner of the advertisement space has installed the advertisement in the purchased advertisement space. If not, at step 614, the pre-payment or deposit money is returned to the user's banking account. If the owner has made the installation, at step 616, web application 102 holds the pre-payment or deposit money in the trust account.

After pre-payment, full payment for the booking is processed. At step 618, checkout module 112 checks whether full payment was processed successfully—if not, at step 620, user device 118 may retry payment or revise their payment method. If full payment is processed successfully, web application 102 takes a service fee which is deposited into the trust account. According to an embodiment, web application 102 holds any taxes charged and collected for the booking in the trust account. According to an embodiment, at steps 624A-N, full payment for the booking is spread out over N number of payments with each payment being made, for example, a month apart and deposited into the advertisement space owner's bank account.

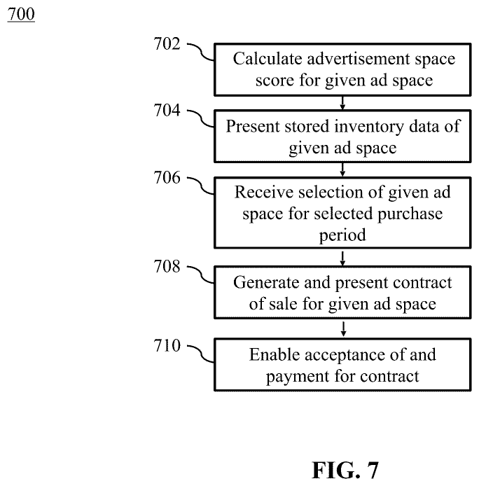

With reference to FIG. 7, a process 700 using system 100 for inventoried physical advertisement space in accordance with some embodiments will now be described. The process of FIG. 7 comprises steps 702 through 710 and is suitable for use in system 100 but is more generally applicable to other types of systems for inventoried physical advertisement space.

At step 702, ad space score calculator 106 of web application 102 calculates an advertisement space score for a selected advertisement space. In some embodiments, the advertisement space score may be calculated based on variables or quantitative factors such as location, size, illumination, and traffic data of an advertisement space. Traffic data may comprise variables such as the number or estimated number of impressions as well as the impression duration of the given advertisement space. The number of impressions may be, for example, a number of daily impressions or views of the advertisement space.

According to an embodiment, ad space score calculator 106 of system 100 utilizes an algorithm to generate the advertisement space score as a weighted combination of the variables. In an embodiment, location is prioritized as a primary weighted variable. In another embodiment, a different one of the variables may be prioritized as a primary weighted variable. In some embodiments, the impression duration variable is weighted more heavily than the number of impressions variables. For example, an advertiser can reason that a stadium of 40,000 people staring at an advertisement for two hours (i.e., impression duration) carries more weight than a highway sign that gets 40,000 impressions (i.e., number of impressions) that are each up to ten seconds long.

At step 704, in response to a request from user device 118, web application 102 recalls and presents stored inventory data from inventory database 104 for the selected advertisement space. The inventory data in inventory database 104 represents the physical advertisement spaces available for purchase. The inventory data comprises data representing the price, location, availability, and the advertisement space score of the advertisement spaces.

At step 706, web application 102 receives a selection of a given advertisement space for a selected purchase period. In some embodiments, the purchase period for the given advertisement space comprises a short-term period of seconds, minutes, hours, days, or weeks, or a monthly or annual subscription. In some embodiments, the purchase period may be all or some of the duration of an event, for example, all or half of the Super Bowl. In some embodiments, the purchase period may be for as little as just a few seconds. For example, an advertiser could afford to lease a given advertisement space that is typically very expensive per unit of time for a very short period of time. The advertiser could thus wish somebody a happy birthday, propose marriage, etc. on a digital display in, for example, Times Square.

At step 708, contract generating module 108 of web application 102 generates and presents a contract of sale for the selected advertisement space. In an embodiment, the contract comprises the price, location, and selected purchase period for the given advertisement space.

At step 710, web application 102 enables acceptance of the contract by user device 118 and checkout module 112 enables payment for the contract.

The particular processing operations and other system functionality described in conjunction with the flow diagrams of FIGS. 2 through 7 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the processes of FIGS. 2-7 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

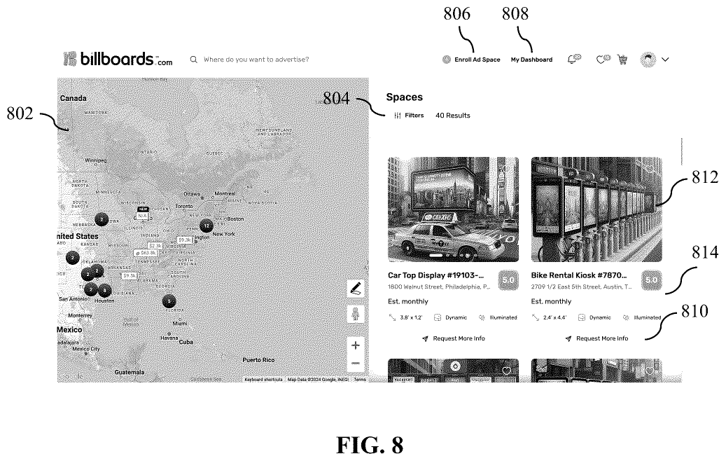

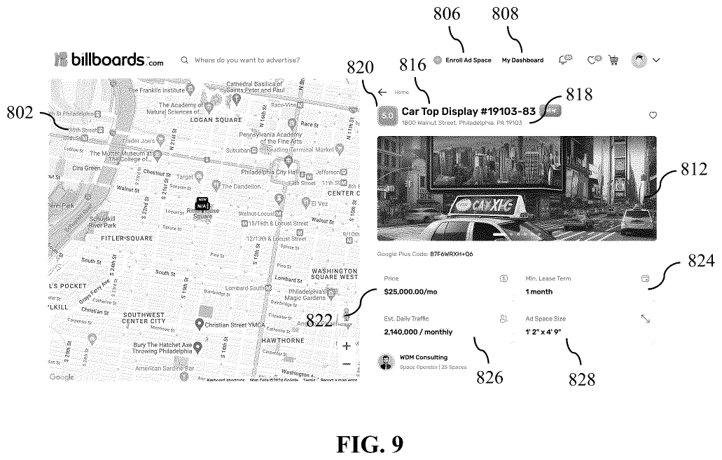

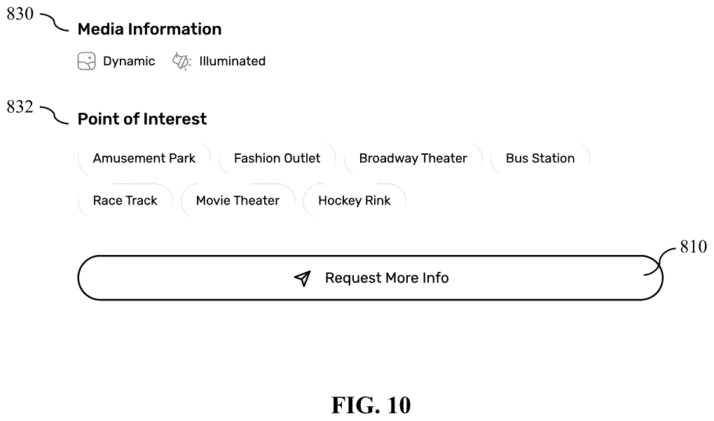

With reference to FIGS. 8 through 12, exemplary interfaces of physical advertisement space inventory system 100, embodied in web application 102, are described. Owner device 120 may upload their inventory of advertisement spaces using an enroll ad space function 806. A dashboard 808 can be selected to view details of advertisement campaigns including campaign performance, as well as manage bookings and account information. User device 118 may search for and filter advertisement spaces available for booking using one or more filters 804. User device 118 may also request additional information regarding a given advertisement space from owner device 120 using a request more info function 810. For example, if user device 118 is interested in leasing a given advertisement space shown without a price quote, user device 118 may select request more info function 810 to be connected to and communicate with owner device 120 to discuss and negotiate price.

In some embodiments, for example, when owner device 120 is unavailable or their contact information is unknown, user device 118 may select request more info function 810 to be connected to a system 100 administrator or manager. Another example where a request more info function 810 inquiry may be directed to a system 100 administrator or manager includes when a given advertisement space is listed on web application 102 by owner device 120A and later sold or otherwise conveyed to owner device 120B, whose contact information is unknown. In an embodiment, the sold or conveyed advertisement space is no longer available for lease or purchase but remains visible to user devices 118 on web application 102. User device 118 may select request more info function 810 to be connected to a system 100 administrator or manager. User device 118 may hire or engage system 100 administrator or manager to perform due diligence regarding the sold or conveyed advertisement space from owner device 120B. Such due diligence may include procuring a price quote or other information regarding the advertisement space for a set fee.

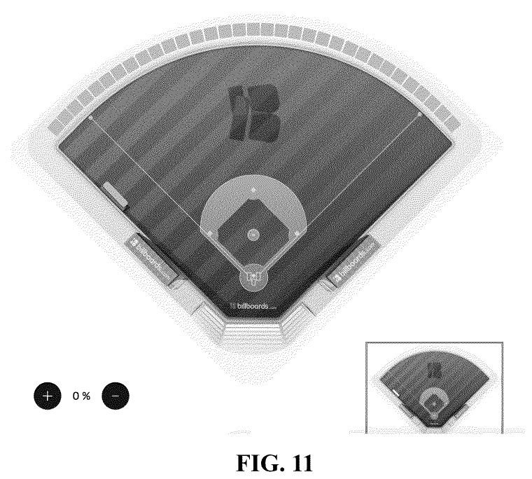

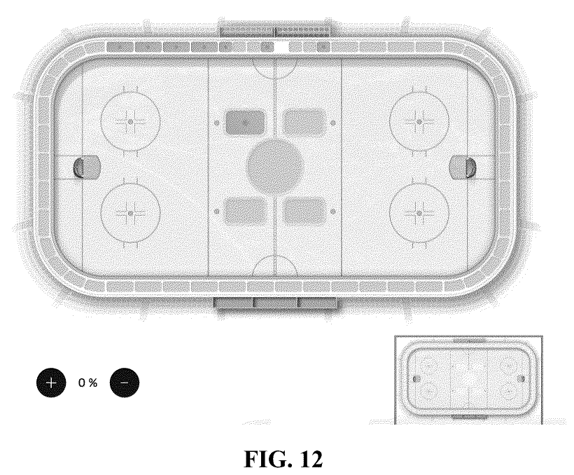

After searching for and filtering advertisement spaces available for booking, any advertisement spaces matching the selected search criteria are displayed as a list and as pins on a map 802. Thus, user device 118 can view advertisement space details 814 which are stored in inventory database 104. Advertisement space details 814 may comprise data representing a name 816, price 822, location 818, and availability of the advertisement space. Other details may include the advertisement space score 820, purchase period option 824, estimated monthly or daily traffic 826, ad space size 828, a visual rendering of the advertisement space 812, media information 830 including whether the advertisement space is configured to display static and/or digital content and whether the advertisement space is illuminated, and point of interest 832. User device 118 may also view a magnified rendering of the available advertisement spaces in a given location, such as a baseball stadium (FIG. 11) or ice rink (FIG. 12), to determine which specific advertisement space they would like to select.

According to an embodiment, dashboard 808 may comprise an admin dashboard or admin panel. The admin panel may comprise multiple functions and features and may be accessed by a system 100 administrator. A system 100 administrator may use the admin panel to read, process, and respond to requests, including new design requests, new installation requests, new car-top enrollment requests, and new venue naming rights enrollment requests. Other functionalities of the admin panel allow a system 100 administrator to manage inventories of owner devices 120 by processing and approving new advertisement spaces, receive and respond to requests or complaints from owner devices 120 regarding the advertisement space score of a given advertisement space or how a given advertisement space is displayed in web application 102, manage campaigns of user devices 118, manage service fees and commission fees, issue payouts, add questions and answers to a Help Center page, add open positions and receive applications in a Job Portal, and add user devices 118 or owner devices 120 that are in breach of web application 102 terms and conditions to a blacklist which uses functionality to ban their account. The Help Center page may include information on creating an account, the booking process, introductory information about web application 102, how to list an advertisement space, and how to contact customer support.

A system 100 administrator may further use the admin panel to upload a potential advertisement space, including photos, location, size, and other information, as an inventory item and mark it as unclaimed. An owner device 120 may use web application 102 to search for and view the unclaimed advertisement space and submit a claim request claiming ownership of the advertisement space. The claim request may include an owner's name, email, company, phone number, ID verification, and other documentation as evidence of ownership of the given advertisement space. The system 100 administrator may view and respond to the claim request by either approving or denying the claim request.

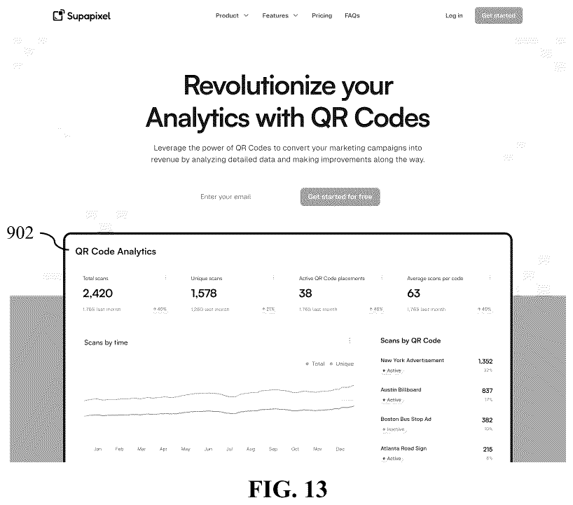

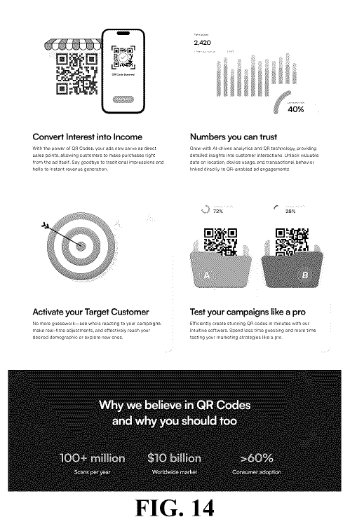

With reference to FIGS. 13 through 14, exemplary interfaces of physical advertisement space inventory system 100, embodied in web application 102, are described. QR code module 113 is configured to generate and analyze QR code analytics 902. QR code analytics 902 includes data on ad engagements including a total number of scans, a number of unique scans, a number of active QR code placements, an average of the number of scans per code, and various list and graphical representations of such analytics.

In some embodiments, QR code module 113 generates a QR code for a given advertisement space, displays the generated QR code on the given advertisement space, and counts a number of scans or interactions with the QR code over a given amount of time. The QR code interaction rate may comprise an average number of QR code interactions for a given advertisement space per unit of time. The QR code may be configured to function as a direct sales point, wherein customers may make purchases right from a given advertisement itself using the unique QR code associated with the advertisement. In some embodiments, traffic data for a given advertisement space comprises the number of scans of the QR code over different periods of time in addition to the number of daily impressions and impression duration of the given advertisement space. In an embodiment, the traffic data comprises a comparison of rates of interaction across, for example, different days of the week or different holiday seasons. The comparison data is collected and aggregated to identify the most and least popular time of day, night or season when a particular QR code is most or least actively engaged.

According to an embodiment, a customer may create a virtual shopping cart account. By interacting with pixel or QR codes in different product advertisements on different displays, the customer may load different products and coupons from different retailers into their virtual shopping cart. The customer may check-out for all items in their shopping cart with a single payment.

In some embodiments, QR code analytics 902 are integrated into the calculation of an advertisement space score. In an example where two billboards have the same size and same advertisement design but differ in location, the billboard whose unique QR code gets 400 interactions per month is assigned a higher advertisement space score than the billboard whose QR code gets 40 interactions per month.

FIGS. 1 through 14 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

1. A physical advertisement space inventory system, the system comprising:
an inventory database storing inventory data, the inventory data representing a plurality of physical advertisement spaces available for lease and comprising at least data representing a price, location, and availability of the advertisement spaces; and
a web application configured to:
in response to a request from a user received over a communication network, present stored inventory data of a plurality of advertisement spaces from the inventory database, the plurality of advertisement spaces being configured to display digital content;
receive a selection from the user of a given advertisement space for a selected lease period, the given advertisement space being associated in the inventory database with one or more stored pre-defined requirements;
receive design files for the given advertisement space from the user;
automatically verify the received design files meet the one or more stored pre-defined requirements of the given advertisement space;
generate and present a lease contract for the given advertisement space, the contract comprising the price, location, and selected lease period for the given advertisement space;
enable an acceptance of and a payment for the contract; and
display the design files on the given advertisement space in real-time following acceptance of and payment for the contract.

2. (canceled)

3. The system of claim 1, wherein the inventory data of the given advertisement space further comprises a visual rendering of the given advertisement space.

4. The system of claim 1, wherein the web application is further configured to allow searches of the inventory database by the user based on any of the inventory data.

5. The system of claim 1, wherein the inventory data of the given advertisement space further comprises an advertisement space score, the advertisement space score being calculated based on variables comprising location, size, illumination, and traffic data comprising number of daily impressions and impression duration of the given advertisement space.

6. (canceled)

7. (canceled)

8. The system of claim 1, wherein the lease period for the given advertisement space comprises a short-term period of seconds, minutes, hours, days, weeks, or all or some of a duration of an event.

9. The system of claim 1, wherein the lease period for the given advertisement space comprises a monthly or annual subscription.

10. A method performed by at least one processor comprising hardware, the method comprising:
calculating, by a web application, an advertisement space score for a given physical advertisement space from an inventory database based on variables comprising location, size, illumination, and traffic data comprising number of daily impressions and impression duration of the given advertisement space;
presenting, by the web application, in response to a request from a user received over a communication network, stored inventory data of a plurality of advertisement spaces from the inventory database, the plurality of advertisement spaces being configured to display digital content, and the inventory data representing a plurality of physical advertisement spaces available for lease and comprising at least data representing a price, location, availability and the advertisement space score of the advertisement spaces;
receiving, by the web application, a selection from the user of a given advertisement space for a selected lease period, the given advertisement space being associated in the inventory database with one or more stored pre-defined requirements;
receiving, by a design files module, design files for the given advertisement space from the user;
automatically verifying, by the design files module, the received design files meet the one or more stored pre-defined requirements of the given advertisement space;
generating and presenting, by the web application, a lease contract for the given advertisement space, the contract comprising the price, location, and selected lease period for the given advertisement space;
enabling, by the web application, an acceptance of and a payment for the contract; and
displaying, by the web application, the design files on the given advertisement space in real-time following acceptance of and payment for the contract.

11. The method of claim 10, wherein calculating an advertisement space score for a given advertisement space comprises calculating an advertisement space score for a given advertisement space based on variables that are weighted, and wherein location is assigned a higher weight than other weighted variables.

12. The method of claim 10, wherein the method further comprises:
generating a quick-response (QR) code for the given advertisement space;
displaying the generated QR code on the given advertisement space; and
counting a number of scans of the QR code in a given amount of time.

13. The method of claim 12, wherein the traffic data further comprises the number of scans of the QR code in a given amount of time.

14. (canceled)

15. The method of claim 10, wherein presenting stored inventory data of a plurality of advertisement spaces further comprises presenting a visual rendering of the plurality of advertisement spaces.

16. The method of claim 10, wherein the web application is further configured to allow searches of the inventory database by the user based on any of the inventory data.

17. (canceled)

18. (canceled)

19. The method of claim 10, wherein the lease period for the given advertisement space comprises a monthly or annual subscription.

20. Non-transitory computer-readable media comprising program code that when executed by a programmable processor causes execution of a method, the computer readable media comprising:
computer program code for calculating an advertisement space score for a given physical advertisement space from an inventory database based on variables comprising location, size, illumination, and traffic data comprising number of daily impressions and impression duration of the given advertisement space;
computer program code for presenting, in response to a request from a user received over a communication network, stored inventory data of a plurality of advertisement spaces from the inventory database, the plurality of advertisement spaces being configured to display digital content, and the inventory data representing a plurality of physical advertisement spaces available for lease and comprising at least data representing a price, location, availability and the advertisement space score of the advertisement spaces;
computer program code for receiving, from the user, a selection of a given advertisement space for a selected lease period, the given advertisement space being associated in the inventory database with one or more stored pre-defined requirements;
computer program code for receiving design files for the given advertisement space from the user;
computer program code for automatically verifying the received design files meet the one or more stored pre-defined requirements of the given advertisement space;
computer program code for generating and presenting a lease contract for the given advertisement space, the contract comprising the price, location, and selected lease period for the given advertisement space;
computer program code for enabling an acceptance of and a payment for the contract; and
computer program code for displaying the design files on the given advertisement space in real-time following acceptance of and payment for the contract.

21. A physical advertisement space inventory system, the system comprising:
an inventory database storing inventory data, the inventory data representing a plurality of physical advertisement spaces available for lease and comprising at least data representing a location and availability of the advertisement spaces; and
a web application configured to:
in response to a request from a user received over a communication network, present stored inventory data of a plurality of advertisement spaces from the inventory database, the plurality of advertisement spaces being configured to display digital content;
receive a selection from the user of a given advertisement space for a selected lease period, the given advertisement space being associated in the inventory database with one or more stored pre-defined requirements;
receive design files for the given advertisement space from the user;
automatically verify the received design files meet the one or more stored pre-defined requirements of the given advertisement space;
facilitate communication between the user and an owner of the given advertisement space to negotiate a price for leasing the given advertisement space for the selected lease period;
generate and present a lease contract for the given advertisement space, the contract comprising the price, location, and selected lease period for the given advertisement space;
enable an acceptance of and a payment for the contract; and
display the design files on the given advertisement space in real-time following acceptance of and payment for the contract.

22. The non-transitory computer-readable media of claim 20, wherein calculating an advertisement space score for a given advertisement space comprises calculating an advertisement space score for a given advertisement space based on variables that are weighted, and wherein location is assigned a higher weight than other weighted variables.

23. The non-transitory computer-readable media of claim 20 further comprising computer program code for:
generating a quick-response (QR) code for the given advertisement space;
displaying the generated QR code on the given advertisement space; and
counting a number of scans of the QR code in a given amount of time.

24. The non-transitory computer-readable media of claim 20, wherein the traffic data further comprises the number of scans of the QR code in a given amount of time.

25. The system of claim 21, wherein the lease period for the given advertisement space comprises a short-term period of seconds, minutes, hours, days, weeks, or all or some of a duration of an event.

26. The system of claim 21, wherein the lease period for the given advertisement space comprises a monthly or annual subscription.
